(19) United States
(12) Patent Application Publication
(10) Pub. No.: US 2010/0083243 A1
(43) Pub. Date: Apr. 1, 2010

(54) SYSTEM AND METHOD FOR DELIVERING SOFTWARE

(75) Inventors: John R. Mincarelli, Weare, NH (US); Sridhar Seetharaman, Austin, TX (US)

Correspondence Address: PVF -- SYNOPSYS, INC;c/o PARK, VAUGHAN & FLEMING LLP, 2820 FIFTH STREET, DAVIS, CA, 95618-7759, US

(73) Assignee: SYNOPSYS, INC., Mountain View, CA (US)

(21) Appl. No.: 12/240,429

(22) Filed: Sep. 29, 2008

(51) Int. Cl. G06F 9/44

(52) U.S. Cl. 717/173

(57) ABSTRACT

Some embodiments of the present invention provide a system for delivering software. During operation, the system receives selections from a user, wherein the selections specify items of software to be delivered from a master site to a user site. The system also receives priority information from the user, wherein the priority information specifies a priority for delivery for the selected items of software. Next, the system determines an order of delivery for the selected items of software based on the priority information. Finally, the system delivers the selected items of software from the master site to the user site in accordance with the determined order of delivery.

### RELATED APPLICATION

This application is related to a U.S. patent application entitled “System and Method for Verifying Delivered Software,” filed on the same day as the instant application, by inventors John Mincarelli and Sridhar Seetharaman application Ser. No. To Be Assigned (Attorney Docket No. SNPS-1153).

### BACKGROUND

1. Field

The present invention generally relates to systems for distributing software over computer networks. More specifically, the present invention relates to a software repository that facilitates delivering software to remote sites and periodically verifying that the remote sites possess valid and up-to-date versions of the delivered software.

2. Related Art

The recent proliferation of high-speed networks makes it significantly easier to distribute computer software to remote sites. However, software distribution can be a complicated process because software distributors often distribute hundreds of different software products, and each product typically has multiple releases. Moreover, software products can be distributed to hundreds or even thousands of sites, wherein each site can potentially use a unique combination of different versions of software products. This complexity is further compounded by system administrators, who are often creative about how they install different software products, which means that each installation is typically different. Each of the above-mentioned factors makes it hard to efficiently distribute and maintain software products.

### SUMMARY

Some embodiments of the present invention provide a system for delivering software. During operation, the system receives selections from a user, wherein the selections specify items of software to be delivered from a master site to a user site. The system also receives priority information from the user, wherein the priority information specifies a priority for delivery for the selected items of software. Next, the system determines an order of delivery for the selected items of software based on the priority information. Finally, the system delivers the selected items of software from the master site to the user site in accordance with the determined order of delivery.

In some embodiments, delivering the selected items of software involves iteratively: sending a selected item of software from the master site to the user site; and receiving confirmation of delivery of the selected item before sending the next selected item of software.

In some embodiments, the system additionally calculates a fee for delivering a selected item of software, wherein the fee is based on: a complexity of installing the selected item of software; a size of the selected item of software; and/or a number of files which comprise the selected item of software. In some embodiments, after the selected items of software are delivered, the system automatically pushes the updates to the selected items of software from the master site to the user site.

In some embodiments, the master site can be: a master site which contains a master repository for software; or a slave site which contains a copy of the master repository.

In some embodiments, the system receives a delivery option from the user, wherein the delivery option can specify whether the selected items of software are to be delivered on a predetermined schedule or on-demand. In these embodiments, delivering the selected items of software involves delivering the selected items of software in accordance with the delivery option. In some embodiments, the system additionally identifies which items of software have not been loaded or used within a preceding time period, and then archives and removes the identified items of software from the master site.

In some embodiments, archiving and removing the identified items of software from the master site involves: compressing the identified items of software; storing the compressed items of software in an archive repository; and removing the identified items of software from a master repository on the master site.

Some embodiments of the present invention provide a system that verifies software which was distributed from a master site to a user site. During operation, the system receives a master list from the master site at the user site, where the master list specifies items of software which could be installed on the user site. The system also generates an actual list on the user site indicating which items of software are actually installed on the user site. The system then compares the actual list with the master list, and if the actual list is inconsistent with the master list, the system performs a remedial action.

In some embodiments, the remedial action can include: automatically notifying a system administrator who is responsible for the user site about the inconsistency; and automatically retransmitting missing, updated or corrupted items of software from the master site to the user site. In some embodiments, the master list is received when the master list is updated on the master site, and the actual list is periodically generated on the user site.

In some embodiments, generating the actual list involves identifying which items of software are installed at the user site, and then verifying that the identified items of software are validly installed at the user site.

In some embodiments, verifying that a given item of software is validly installed involves verifying the following attributes for the given item of software: a version number, a number of files, and/or a size of an install, and/or a checksum.

### BRIEF DESCRIPTION OF THE FIGURES

FIG. 1 illustrates a networked set of computer systems in accordance with an embodiment of the present invention.

FIG. 2A illustrates the structure of the master site in accordance with an embodiment of the present invention.

FIG. 2B illustrates the structure of a user site in accordance with an embodiment of the present invention.

FIG. 3 presents a flow chart illustrating the process of distributing software in accordance with an embodiment of the present invention.

FIG. 4 presents a flow chart illustrating the process of automatically verifying and updating software in accordance with an embodiment of the present invention.

FIG. 5 presents a flow chart illustrating the process of archiving and removing software from the master repository in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### System

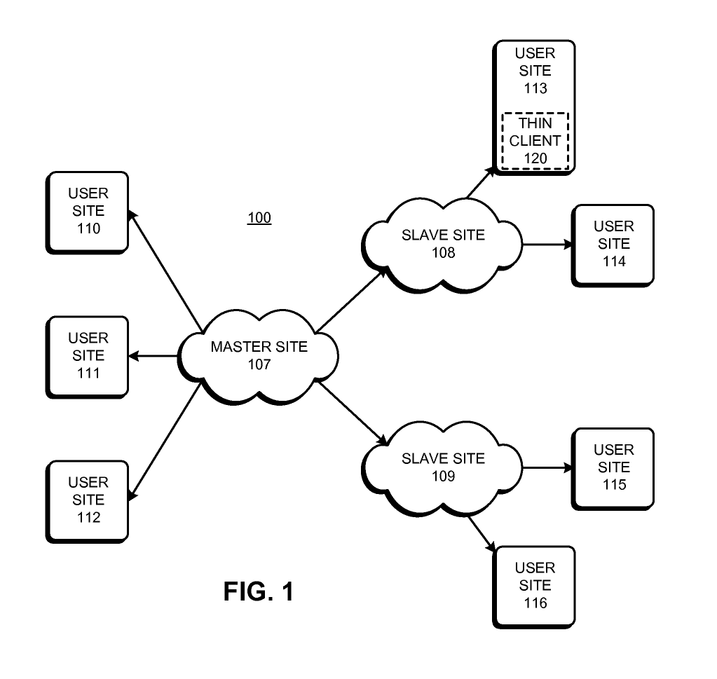

FIG. 1 illustrates a networked set of computer systems in accordance with an embodiment of the present invention. More specifically, the exemplary system illustrated in FIG. 1 includes a master site 107, which contains a master repository containing software which is ultimately distributed to a number of user sites 110-116. Master site 107 also propagates software to slave sites 108-109, which contain local copies of the master repository. These copies function as “second-tier repositories,” which can be used to distribute software to user sites which are generally closer to the slave sites. More specifically, referring to FIG. 1, slave site 108 distributes software to user sites 113-114, and slave site 109 distributes software to user sites 115-116. Note that if an item of software is not available at a slave site 108, it is possible for master site 107 to bypass slave site 108 and distribute the item of software directly to user site 114. (Note that the item of software can be delivered concurrently or subsequently to slave site 108.)

Moreover, each user site includes a thin client for the system, which can be easily installed on different computing platforms, and which facilitates data transfers between master site 107 and slave sites 108-109. More specifically, in FIG. 1 user site 113 includes a thin client 120, which contains code that facilitates delivering software from slave site 108 to user site 113. For example, thin client 120 can include a web-based graphical user interface (GUI) which enables a user to select items of software to be delivered, as well as associated delivery options. This web-based GUI can also enable the user to select between various distribution protocols.

Note that sites 107-116 can belong to different organizations, or can alternatively belong to the same organization. For example, in one embodiment of the present invention, master site 107 and slave sites 108-109 belong to a software distributor, and user sites 110-116 belong to customers of the software distributor. In another embodiment, master site 107, slave sites 108-109 and user sites 110-116 all belong the same organization, wherein user sites 110-116 are geographically distributed offices of the organization.

The above-mentioned sites 107-116 can generally include any type of computer system or computing device, which can be based on a microprocessor, a mainframe computer, a digital signal processor, a portable computing device, a personal organizer, a device controller, or a computational engine within an appliance.

Sites 107-116 communicate with each other through a network (not shown), which can include any type of wired or wireless communication channel capable of coupling together computing nodes. This network can include, but is not limited to, a local area network, a wide area network, or a combination of networks. In one embodiment of the present invention, the network includes the Internet. In some embodiments of the present invention, the network includes phone and cellular phone networks.

### Master Site

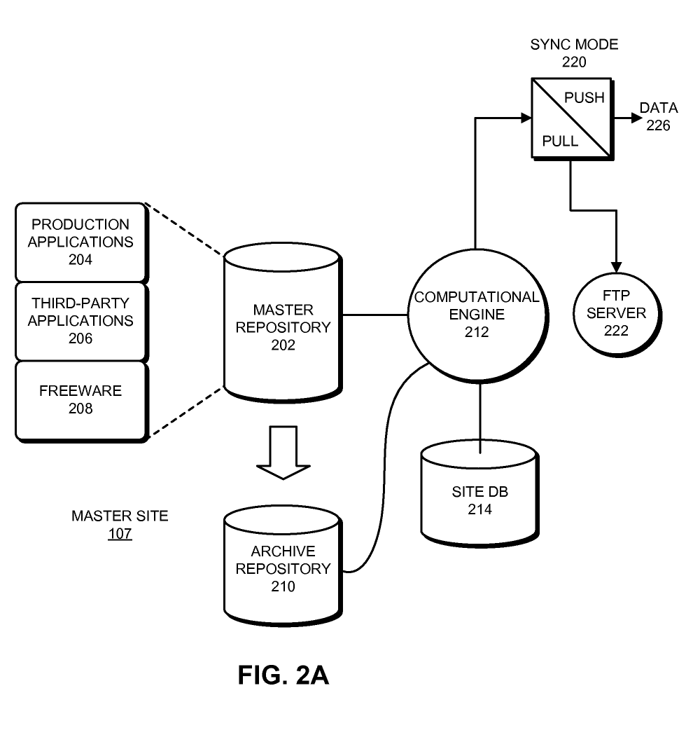

FIG. 2 illustrates the structure of master site 107 in accordance with an embodiment of the present invention. Master site 107 includes a computational engine 212, which communicates with a master repository 202, an archive repository 210 and a site database (site DB) 214.

As mentioned above, computational engine 212 can generally include any type of computer system or computing device, which can be based on a microprocessor, a mainframe computer, a digital signal processor, a portable computing device, a personal organizer, a device controller, or a computational engine within an appliance.

Master repository 202 stores production versions of different items of software, which, for example, can include different software modules, software packages, software applications and/or software tools. More specifically, master repository 202 can comprise different disk slices, which contain different types of software. For example, master repository 202 can contain disk slices for production applications 204, third-party applications 206 and freeware 208. Note that master repository 202 can also store other types of non-software content, such as data files containing textual information, or media files containing images, sounds or video.

Archive repository 210 contains compressed representations for different software items or other types of content which are no longer being accessed or used at user sites 110-116.

Site DB 214 contains information about which items of software are stored on specific user sites. For example, site DB can store: site identifiers, sites names, names for customers associated with the user sites, contact information for customers, and delivery information indicating which software items are to be delivered to which sites and when specific software items were delivered to specific sites. Site DB 214 also stores the preferred delivery method (eg: rsync, ftp) for a user site. It additionally stores all dependency information that has to be delivered along with the media to a site. This dependency information can include, but is not limited to, specifiers for, a modulefile, a default version file or any other application/media directory. Note that some of the above-described information can be used for billing purposes as is described in more detail below.

Site DB 214 additionally contains usage information which specifies how items of software are used. More specifically, the usage information can indicate (1) the date and time the item of software was accessed, (2) the associated user, (3) the associated machine, (3) the category and version number for the item of software, and (5) whether the item of software was loaded or unloaded. Note that this information can be used during the archive-and-removal process as is described in more detail below. This information can also be used to proactively register a user to receive updates for a category of software. For example, if the system determines that the user is frequently accessing items from a specific category, the system can automatically register the user to receive updates for software in the specific category based on trending analysis.

Note that master site 107 can distribute software to user sites using either a “push model” or a “pull model.” More specifically, master site 107 includes a mode-selection mechanism 200, which selects the synchronization mode to be either “push” or “pull.” Under a push model, data 226 (including items of software) is directly pushed, either from the master site 107 or a slave site, to user sites. In contrast, under a pull model, master site 107 sends a notification (such as an email message) to a user site indicating that an item of software is ready to be downloaded from a designated file transfer protocol (FTP) server 222. Note that each customer is allocated a private non-published and secure area on the FTP server 222. Moreover, the FTP server 222 is configured to be blind and unidirectional, for download by the customer only. Also note that the FTP download requires a registered username and password. The user site then downloads the item of software when the user site is ready to do so. Note that FTP server 222 will automatically delete all user site software deliveries after a specified period of time.

In one embodiment of the present invention, the system can selectively use different distribution protocols to distribute the software, such as the “rsync” protocol (which synchronizes UNIX files and directories), remote shell (RSH) protocol, secure shell (SSH) protocol or FTP.

In one embodiment of the present invention, the system creates parallel streams to send a new or modified item of software to different customers in parallel, wherein there is a separate stream for each customer. Note that within each stream, items of software can be distributed serially. Hence, if three items of software are to be sent to a given customer, the three items of software will be sent in a dedicated stream to the given customer. However, within the dedicated stream, the three items of software will be sent serially.

In some embodiments, the system also supports time-based delivery, wherein the delivery of items of software can be delayed to occur during less busy times, typically off-business hours, to minimize possible bandwidth contention issues which would impact the user site users of their Internet connection.

In some embodiments, the system also keeps track of dependencies between packages associated with software tools. This enables the system, for example, to deliver supplementary packages, such as module files or library files, after the other packages that comprise a software tool have been delivered.

In some embodiments, when distributing software to user sites, the system automatically changes hard-coded pathnames in program code so that the pathnames map to valid locations in different directory structures at different user sites. This can involve both a site-level mapping and application-level mapping. For example, for sites belonging to the ABC company, the system can automatically map “/remote/foobar” to “/remote/ABC”. However, for Synthesis applications on sites belonging to the ABC company, the system can automatically map “/remote/foobar” to “/remote/ABC/synthesis”.

In some embodiments, computational engine 212 at master site 107 performs “update checking” operations to determine whether master repository 202 contains new or updated items of software which need to be distributed to user sites. More specifically, the update checking involves first creating a list compilation of all items in the repository and comparing the compilation to the last generated compilation to determine if a new category item has been added.

(The computational engine 212 can create and compare the list of items N times per day via a specified configuration setting.) The update checking also involves a second-level check of the modification time for the entire repository in master repository 202 to determine if anything has changed. If the modification time indicates something has changed, the system identifies any new or modified items of software in master repository 202. This enables the system to distribute the new or modified items of software to user sites as necessary.

In some embodiments, the system supports a self-monitoring multi-level notification/network latency detection feature. In these embodiments, computational engine 122 has the ability (via a multi-level monitoring technique) to monitor its own sync status by checking if a sync is making progress in the delivery of the content to a specific user site, and if the throughput rate for the specific user site is within a pre-determined acceptable range. More specifically, in some embodiments, the system supports two levels of monitoring, which includes (1) monitoring sync status and (2) monitoring throughput.

While monitoring sync status, computational engine 212 checks if the sync(s) to a user site are making expected progress. If a sync process is running longer than a predetermined period of time for a specific user site, computational engine 212 can send a communication alert, in the form of an email message, to advise the administrators of the system that an issue has been detected and required service level agreements (SLAs) are possibly not be being met. Note that each user site can be programmed independently to specify the appropriate duration of a valid sync process and to specify person(s) to be notified in the event of an issue. Moreover, computational engine 212 can be configured to check the status of each user site sync at predetermined times.

While monitoring throughput, computational engine 212 checks the throughput rate for each delivery to a user site to detect any detrimental changes in the network bandwidth. Such detrimental changes can cause reduced bandwidth and can thereby cause the throughput for a delivery to a user site to fall below established criteria for such deliveries. If the throughput rate is reduced from previous and established rates for a specified user site, a communication alert, in the form of an email message, can be sent to the administrators. More specifically, after each delivery, computational engine 212 can compare the current throughput for each delivery to the expected throughput for a site and can alert the administrators if there is a significant decrease in the throughput for the most-recent delivery. This check can be performed on each unique sync stream to a user site as registered in computational engine 212.

### User Site

FIG. 2B illustrates the structure of a user site 113 in accordance with an embodiment of the present invention. User site 113 includes a user repository 232 which contains local copies of items of software which were previously acquired from master site 107.

User site 113 also includes a disk space monitor 234, which keeps track of how much disk space is available in user repository 232. During the software delivery process, disk space monitor 234 determines whether user site 113 has enough space to accommodate the delivery. This can involve comparing the available disk space with the size of the item of software to be delivered (and various threshold values). If necessary, the system sends a two-level alert which either notifies a system administrator (or other responsible people) that (1) disk space is “low” and the deliveries are continuing, or (2) disk space is “critically low” and the subsequent delivery cannot be facilitated.

User site 113 additionally includes an application usage analyzer 230, which keeps track of usage information for items of software. As mentioned above, this usage information can specify (1) the date and time the item of software was accessed, (2) the associated user, (3) the associated machine, (3) the category and version number for the item of software, and (5) whether the item of software was loaded or unloaded. Note that this information can be communicated to master site 107 to be used during the archive-and-removal process as is described in more detail below. The usage information optionally enables an automated sync from computational engine 212 of the most heavily utilized media to the targeted user site.

### Distributing Software

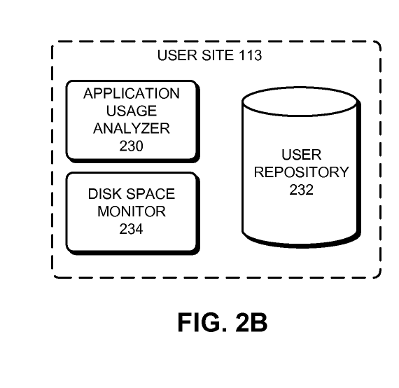

FIG. 3 presents a flow chart illustrating the process of distributing software in accordance with an embodiment of the present invention. During operation, the system receives selections from a user, wherein the selections specify items of software to be delivered from a master site to a user site (step 302). Note that the selections can be received from users who are located at one of the user sites. Moreover, the selections can be associated with a purchase agreement, a licensing agreement or other type of contract to use the software.

The system can also receive other types of information from the user. For example, the system can additionally receive priority information from the user, which specifies a priority for delivery for the selected items of software (step 304). This enables the system to deliver more important or more time-critical items of software first. The system can also receive a delivery option from the user, wherein the delivery option specifies how the selected items of software are to be delivered (step 306). For example, the selected items of software can be delivered based on a predetermined schedule, or alternately they can be delivered on-demand, when the user requests delivery.

Next, the system determines a desired order of delivery based on the priority information (step 308). The system then delivers the selected items of software from the master site 107 to the user site in accordance with the determined order of delivery and the selected delivery option. During this process, the system iteratively: sends a selected item of software from the master site to the user site (step 310); and verifies delivery of the selected item before sending the next selected item of software (step 312). Note that if the delivery for a given item of software cannot be verified, the system can resend the given item of software. (In contrast, under a pull model, the master site 107 sends a notification to the user site indicating that a selected item of software is ready to be delivered, and the user site pulls the software from the FTP server 222 within master site 107.)

In some embodiments, the system additionally calculates a fee for delivering a selected item of software (step 314). For example, the fee can be based on: a complexity of installing the selected item of software; a size of the selected item of software; and/or a number of files which comprise the selected item of software. The system can then bill the user based on the calculated fee. The bill can also include different delivery costs for media which originates from different sources and these different delivery costs can be incorporated into the same bill.

In some embodiments of the present invention, after the selected items of software are delivered, the system automatically pushes updates to the selected items of software from the master site to the user site and any other user site that has loaded the same piece of software (step 316).

### Verifying and Updating Software

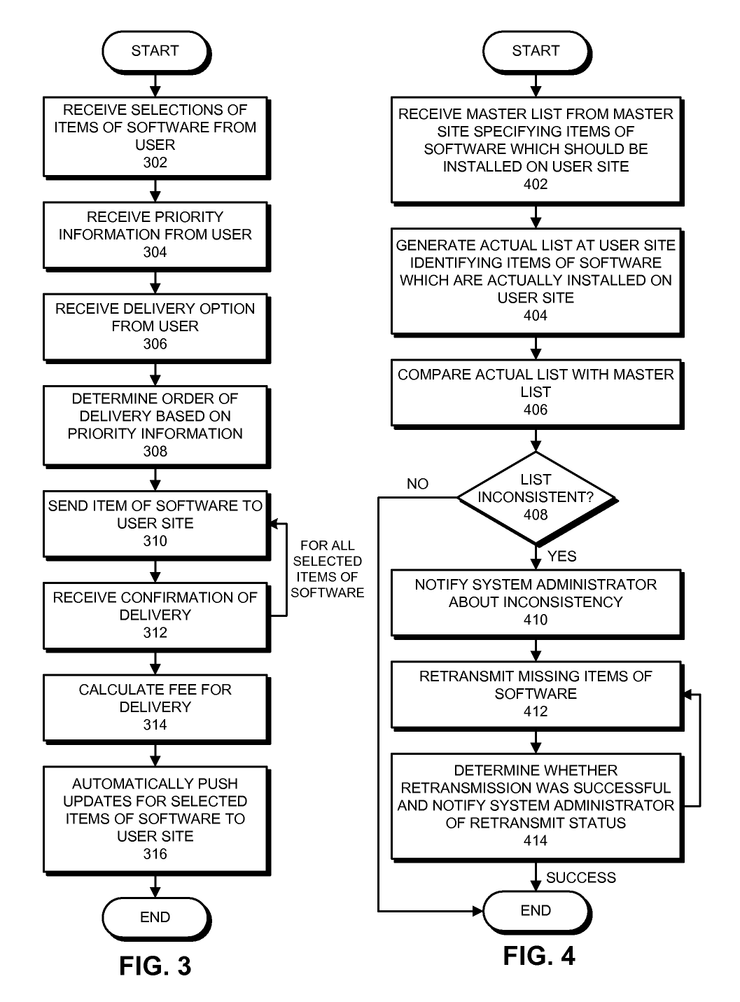

FIG. 4 presents a flow chart illustrating the process of automatically verifying and updating software in accordance with an embodiment of the present invention. During operation, the system receives a master list (also referred to as a “manifest”) from the master site 107 at the user site, wherein the master list specifies items of software which could be installed on the user site (step 402). In some embodiments, the master list is received whenever the master list is updated on the master site.

The system also periodically generates an actual list (manifest) on the user site indicating which items of software are actually installed on the user site (step 404). Note that this process can involve identifying which items of software are installed at the user site, and then verifying that the identified items of software are validly installed at the user site. In some embodiments, verifying that a given item of software is validly installed involves verifying the following attributes for the given item of software: a version number, a number of files, and/or a size of an install, and/or a checksum.

The system then compares the actual list with the master list (step 406). If the actual list is inconsistent with the master list (step 408—yes), the system performs a remedial action, which can include automatically notifying a system administrator, who is responsible for the user site, about the inconsistency (step 410). It can also include automatically retransmitting missing, updated or corrupted items of software from the master site to the user site (step 412). After a retransmission, the system determines whether the retransmission was successful by performing a check at the user site. The system then notifies the system administrator about the retransmission status (step 414). If the retransmission was unsuccessful, the system may return to step 412 to retransmit the item of software again (as is indicated by the return arrow from step 414 to step 412.) After retransmitting unsuccessfully N times, the system can notify the administrator of the problem and can advise the administrator that a manual retransmission may be required to resolve and/or debug the issue.

### Archiving and Removing Software

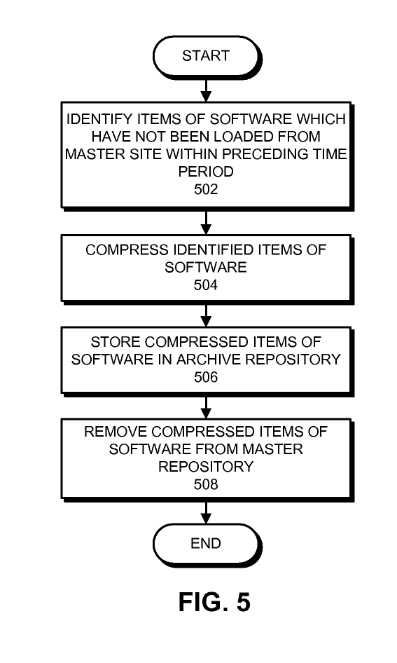

FIG. 5 presents a flow chart illustrating the process of archiving and removing software from the master repository in accordance with an embodiment of the present invention. During this process, the system identifies which items of software have not been loaded or used at a user site within a preceding time period (step 502). For example, each user site can keep track of which items of software were loaded at the user site. This information can then be periodically sent to the master site. This enables the master site to identify which items of software have not been loaded at any user site for a preceding time period, say 90 days. The fact that an item of software has not been loaded in the preceding time period indicates that the item of software is not likely to be loaded in the future.

Next, in order to conserve disk space in the master repository, the system archives and removes the identified items of software from the master repository. This can involve: compressing the identified items of software (step 504); storing the compressed items of software in an archive repository (step 506); and removing the identified items of software from a master repository on the master site (step 508).

Note that it is possible to restore an archived item of software if it is requested in the future. This involves: retrieving the item of software from the archive repository; decompressing the item of software; and then restoring the decompressed item of software to the master repository so it can be distributed to a user site as needed.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for delivering software, comprising:
receiving selections from a user, wherein the selections specify items of software to be delivered from a master site to a user site;
receiving priority information from the user, wherein the priority information specifies a priority for delivery for the selected items of software;
determining an order of delivery for the selected items of software based on the priority information; and
delivering the selected items of software from the master site to the user site in accordance with the determined order of delivery.

2. The method of claim 1, wherein delivering the selected items of software involves iteratively:
sending a selected item of software from the master site to the user site; and
receiving confirmation of delivery of the selected item before sending the next selected item of software.

3. The method of claim 1, wherein the method further comprises calculating a fee for delivering a selected item of software based on one or more of the following:
a complexity of installing the selected item of software;
a size of the selected item of software; and
a number of files which comprise the selected item of software.

4. The method of claim 1, wherein after the selected items of software are delivered, the method further comprises automatically pushing the updates to the selected items of software from the master site to the user site.

5. The method of claim 1, wherein the master site can be:
a master site which contains a master repository for software; or
a slave site which contains a copy of the master repository.

6. The method of claim 1,
wherein the method further comprises receiving a delivery option from the user, wherein the delivery option can specify whether the selected items of software are to be delivered on a predetermined schedule or on-demand; and
wherein delivering the selected items of software involves delivering the selected items of software in accordance with the delivery option.

7. The method of claim 1, wherein the method further comprises:
identifying which items of software have not been loaded and/or used within a preceding time period; and
archiving and removing the identified items of software from the master site.

8. The method of claim 7, wherein archiving and removing the identified items of software from the master site involves:
compressing the identified items of software;
storing the compressed items of software in an archive repository; and
removing the identified items of software from a master repository on the master site.

9. The method of claim 1,
wherein the method further comprises monitoring progress while delivering the selected items of software; and
if the monitored progress does not meet a pre-determined requirement, alerting a system administrator.

10. The method of claim 9, wherein monitoring the progress involves:
determining whether syncs from the master site to the user site are satisfying a predetermined minimum level of progress; and/or
determining whether throughput to the user site is satisfying a predetermined minimum level of throughput.

11. A computer-readable storage medium storing instructions that when executed by a computer cause the computer to perform a method for delivering software, the method comprising:
receiving selections from a user, wherein the selections specify items of software to be delivered from a master site to a user site;
receiving priority information from the user, wherein the priority information specifies a priority for delivery for the selected items of software;
determining an order of delivery for the selected items of software based on the priority information; and
delivering the selected items of software from the master site to the user site in accordance with the determined order of delivery.

12. The computer-readable storage medium of claim 11, wherein delivering the selected items of software involves iteratively:
sending a selected item of software from the master site to the user site; and
receiving confirmation of delivery of the selected item before sending the next selected item of software.

13. The computer-readable storage medium of claim 11, wherein the method further comprises calculating a fee for delivering a selected item of software based on one or more of:
a complexity of installing the selected item of software;
a size of the selected item of software; and
a number of files which comprise the selected item of software.

14. The computer-readable storage medium of claim 11, wherein after the selected items of software are delivered, the method further comprises automatically pushing the updates to the selected items of software from the master site to the user site.

15. The computer-readable storage medium of claim 11, wherein the master site can be:
a master site which contains a master repository for software; or
a slave site which contains a copy of the master repository.

16. The computer-readable storage medium of claim 11,
wherein the method further comprises receiving a delivery option from the user, wherein the delivery option can specify whether the selected items of software are to be delivered on a predetermined schedule or on-demand; and
wherein delivering the selected items of software involves delivering the selected items of software in accordance with the delivery option.

17. The computer-readable storage medium of claim 11, wherein the method further comprises:
identifying which items of software have not been loaded and/or used within a preceding time period; and
archiving and removing the identified items of software from the master site.

18. The computer-readable storage medium of claim 17, wherein archiving and removing the identified items of software from the master site involves:
compressing the identified items of software;
storing the compressed items of software in an archive repository; and
removing the identified items of software from a master repository on the master site.

19. The computer-readable storage medium of claim 11,
wherein the method further comprises monitoring progress while delivering the selected items of software; and
if the monitored progress does not meet a pre-determined requirement, alerting a system administrator.

20. The computer-readable storage medium of claim 19, wherein monitoring the progress involves:
determining whether syncs from the master site to the user site are satisfying a predetermined minimum level of progress; and/or
determining whether throughput to the user site is satisfying a predetermined minimum level of throughput.

21. An apparatus that delivers software, comprising:
a receiving mechanism configured to receive selections from a user, wherein the selections specify items of software to be delivered from a master site to a user site;
wherein the receiving mechanism is additionally configured to receive priority information from the user, wherein the priority information specifies a priority for delivery for the selected items of software;
a scheduling mechanism configured to schedule an order of delivery for the selected items of software based on the priority information; and
a delivery mechanism configured to deliver the selected items of software from the master site to the user site in accordance with the determined order of delivery.

22. The apparatus of claim 21, wherein the delivering mechanism is configured to iteratively:
send a selected item of software from the master site to the user site; and
receive confirmation of delivery of the selected item before sending the next selected item of software.

23. The apparatus of claim 21, wherein the apparatus further comprises a fee-calculation mechanism configured to calculate a fee for delivering a selected item of software based on one or more of:
a complexity of installing the selected item of software;
a size of the selected item of software; and
a number of files which comprise the selected item of software.

24. The apparatus of claim 21, wherein after the selected items of software are delivered, the delivery mechanism is configured to automatically push the updates to the selected items of software from the master site to the user site.

25. The apparatus of claim 21, wherein the master site can be:
a master site which contains a master repository for software; or
a slave site which contains a copy of the master repository.

26. The apparatus of claim 21,
wherein the delivery mechanism is configured to receive a delivery option from the user, wherein the delivery option can specify whether the selected items of software are to be delivered on a predetermined schedule or on-demand; and
wherein while delivering the selected items of software, the delivery mechanism is configured to deliver the selected items of software in accordance with the delivery option.

27. The apparatus of claim 21, further comprising an archiving mechanism configured to:
identify which items of software have not been loaded and/or used within a preceding time period; and to
archive and remove the identified items of software from the master site.

28. The apparatus of claim 27, wherein while archiving and removing the identified items of software, the archiving mechanism is configured to:
compress the identified items of software;
store the compressed items of software in an archive repository; and
remove the identified items of software from a master repository on the master site.

29. The apparatus of claim 21, further comprising a progress-monitoring mechanism configured to:
monitor progress while delivering the selected items of software; and
if the monitored progress does not meet a pre-determined requirement, alert a system administrator.

30. The apparatus of claim 29, wherein while monitoring progress, the progress-monitoring mechanism is configured to:
determine whether syncs from the master site to the user site are satisfying a predetermined minimum level of progress; and/or
determine whether throughput to the user site is satisfying a predetermined minimum level of throughput.
